(19) United States
(12) Patent Application Publication
(10) Pub. No.: US 2026/0167051 A1
(43) Pub. Date: Jun. 18, 2026

(54) BATTERY SWAP SYSTEM AND A METHOD THEREOF

(71) Applicants: HYUNDAI MOTOR COMPANY, Seoul (KR); KIA CORPORATION, Seoul (KR)

(72) Inventor: Dae Hyun Kim, Hwaseong-si (KR)

(73) Assignees: HYUNDAI MOTOR COMPANY, Seoul (KR); KIA CORPORATION, Seoul (KR)

(21) Appl. No.: 19/226,963

(22) Filed: Jun. 3, 2025

(30) Foreign Application Priority Data
Dec. 13, 2024 (KR) 10-2024-0186421

(51) Int. Cl. B60L 53/80; B60L 53/65; G06F 21/60; G07C 5/00; H01M 10/42; H01M 50/249

(52) U.S. Cl. CPC B60L 53/80; B60L 53/65; G06F 21/602; G07C 5/006; G07C 5/008; H01M 50/249; H01M 10/425; H01M 2010/4271; H01M 2220/20

(57) ABSTRACT

A server includes a memory that stores computer-executable instructions, and at least one processor that accesses the memory to execute the instructions. The at least one processor receives first battery pack information from a vehicle, receives identification information of the battery swap station and second battery pack information from the battery swap station, determines whether a target battery pack associated with the second battery pack information is mountable in or configured to interface with the vehicle based on the first battery pack information and the second battery pack information, and transmits a request to open a slot to the battery swap station to the battery swap station based on a determination that the target battery pack is mountable in or configured to interface with the vehicle.

### CROSS-REFERENCE TO RELATED APPLICATION

This application claims the benefit of and priority to Korean Patent Application No. 10-2024-0186421, filed in the Korean Intellectual Property Office on Dec. 13, 2024, the entire contents of which are incorporated herein by reference.

### TECHNICAL FIELD

The present disclosure relates to a battery swap system and a method thereof, and more specifically, to a technology for exchanging shared batteries for vehicles.

### BACKGROUND

A battery pack swap system for electric vehicles lacks a system capable of diagnosing a battery failure in advance or efficiently managing a swap process. Currently, a faulty battery pack may be exchanged at a station, but there is no procedure to diagnose the state of a battery pack or verify a battery pack through a server before exchange, which may lead to inefficient operation. This may lead to problems such as faulty battery packs being omitted in an exchange process or not being properly replaced.

In addition, exchange of information between a vehicle and a battery station is limited, so it is not easily achievable to safely replace a battery pack that is compatible with the vehicle. One of the reasons is that the vehicle's software package version or battery management system (BMS) information is not checked in real time with respect to battery pack information provided by the station.

### SUMMARY

In view of the foregoing, there is a need to develop technology capable of performing real-time data exchange and compatibility checks between a server, a vehicle, and a battery station.

The present disclosure has been made to solve the above-mentioned problems while advantages achieved by the prior art are maintained intact.

An aspect of the present disclosure provides a battery swap system and a method thereof, which minimizes or reduces the likelihood that a faulty battery pack is missed or otherwise a problem arises during the swap process by allowing a battery pack to be submitted for exchange after a server has verified diagnostic information for the battery pack in advance.

An aspect of the present disclosure provides a battery swap system and a method thereof, which prevents vehicle performance degradation and safety issues and improves user experience by checking a vehicle's software package version and in-station battery pack information in real-time to ensure that only battery packs that are exactly compatible with the vehicle are exchanged.

An aspect of the present disclosure provides a battery swap system and a method thereof, which prevents the use of non-verified battery packs and increases the reliability and safety of vehicles and stations by encrypting battery pack information in a server for cross-checking to ensure that the battery packs provided at a station are verified products.

The technical problems to be solved and advantages provided by the present disclosure are not limited to the aforementioned problems and advantages, and any other technical problems and advantages not mentioned herein should be clearly understood from the following description by those having ordinary skill in the art to which the present disclosure pertains.

According to an aspect of the present disclosure, a server includes a memory that stores computer-executable instructions, and a processor configured to access the memory to execute the instructions. The processor receives first battery pack information from a vehicle, receives identification information of a battery swap station and second battery pack information from the battery swap station, determines whether a target battery pack associated with the second battery pack information is mountable in or configured to interface with the vehicle based on the first battery pack information and the second battery pack information, and transmits a request to open a slot to the battery swap station based on a determination that the target battery pack is mountable in or configured to interface with the vehicle.

According to an embodiment, the processor may receive vehicle information from the vehicle. The vehicle information may include a vehicle identification number (VIN) of the vehicle and a software package version of the vehicle. The first battery pack information may include first identification information of an existing battery pack included in the vehicle, first battery management system (BMS) information of the existing battery pack, and first diagnostic information of the existing battery pack. The second battery pack information may include second identification information of the target battery pack included in the battery swap station, second BMS information of the target battery pack, and second diagnostic information of the target battery pack.

According to an embodiment, the processor may determine whether the existing battery pack is faulty or in a prohibited condition based on the first diagnostic information. The processor may further transmit, to the vehicle, a result message indicating that exchange is not possible or is not to be performed at the battery swap station based on a determination that the existing battery pack is faulty or in a prohibited condition. The processor may also transmit, to the vehicle, a guidance message regarding repair of the existing battery pack based on the result message being transmitted to the vehicle.

According to an embodiment, the processor may identify identification information of a target station (also referred to as “a desired station”) for battery pack exchange of the vehicle, included in the station information for battery pack exchange, based on a determination that the existing battery pack is not faulty or not in a prohibited condition. The processor may also determine, based on the first battery pack information and the second battery pack information, whether the target battery pack is mountable in or configured to interface with the vehicle based on the identification information of the desired station being identical to the identification information of the battery swap station.

According to an embodiment, the processor may identify a version of a battery pack mountable in or configured to interface with the vehicle based on the VIN and the software package version, and determine that the target battery pack is the battery pack mountable in or configured to interface with the vehicle based on the identified version of the battery pack mountable in or configured to interface with the vehicle being identical to the second BMS information.

According to an embodiment, the processor may request, from the battery swap station, information regarding a battery pack different from the target battery pack among battery packs included in the battery swap station based on the identified version of the battery pack mountable in or configured to interface with the vehicle being different from the second BMS information.

According to an embodiment, the processor may request identification information of a slot in which the target battery pack is stored based on a determination that the target battery pack is the battery pack mountable in or configured to interface with the vehicle, transmit the request to open the slot to the battery swap station based on receiving the identification information of the slot in which the target battery pack is stored from the battery swap station. The processor may further encrypt the second battery pack information and transmit the encrypted second battery pack information and a symmetric key to the vehicle.

According to an aspect of the present disclosure, a battery swap system includes a battery swap station, a vehicle, and a server. The battery swap station receives, from the vehicle, first battery pack information regarding an existing battery pack that is scheduled to be released, determines to open a slot in which a target battery pack is stored in response to a request to open the slot based on receiving, from the server, the request to open the slot, identifies or determines a coupling of a new battery pack to the slot after the slot is opened and a release of the target battery pack is identified or determined, and performs a verification of the new battery pack based on the new battery pack being coupled to the slot.

According to an embodiment, the battery swap station may identify first identification information and first BMS information included in the first battery pack information received from the server, identify identification information of the new battery pack and BMS information of the new battery pack, determine whether the first identification information is identical to the identification information of the new battery pack, and determine whether the first BMS information is identical to the BMS information of the new battery pack.

According to an embodiment, the battery swap station may transmit an unverified result to the server based on a determination that the first identification information is not identical to the identification information of the new battery pack, or a determination that the first BMS information is not identical to the BMS information of the new battery pack. The battery swap station may further transmit, to a user terminal, an error message indicating that the existing battery pack is unable or not in a condition to be exchanged based on the unverified result being transmitted to the server.

According to an embodiment, the vehicle may receive, from the server, encrypted second battery pack information and a symmetry key, and perform a verification of the target battery pack coupled to the vehicle based on the encrypted second battery pack information and the symmetry key.

According to an aspect of the present disclosure, a battery swap method includes: receiving first battery pack information from a vehicle; receiving identification information of a battery swap station and second battery pack information from the battery swap station; determining whether a target battery pack associated with the second battery pack information is mountable in or configured to interface with the vehicle based on the first battery pack information and the second battery pack information; and transmitting a request to open a slot to the battery swap station based on a determination that the target battery pack is mountable in or configured to interface with the vehicle.

According to an embodiment, transmitting the request to open the slot to the battery swap station may include receiving vehicle information from the vehicle. The vehicle information may include a vehicle identification number (VIN) of the vehicle and a software package version of the vehicle. The first battery pack information may include first identification information of an existing battery pack included in the vehicle, first BMS information of the existing battery pack, and first diagnostic information of the existing battery pack. The second battery pack information may include second identification information of the target battery pack included in the battery swap station, second BMS information of the target battery pack, and second diagnostic information of the target battery pack.

According to an embodiment, transmitting the request to open the slot to the battery swap station may include: determining whether the existing battery pack is faulty or in a prohibited condition based on the first diagnostic information; transmitting, to the vehicle, a result message indicating that exchange is not possible or is not to be performed at the battery swap station based on a determination that the existing battery pack is faulty or in a prohibited condition; and transmitting, to the vehicle, a guidance message regarding repair of the existing battery pack based on the result message being transmitted to the vehicle.

According to an embodiment, transmitting the request to open the slot to the battery swap station may include: identifying identification information of a desired station for battery pack exchange of the vehicle, included in the station information for battery pack exchange, based on a determination that the existing battery pack is not faulty or not in a prohibited condition; and determining,, based on the first battery pack information and the second battery pack information, whether the target battery pack is mountable in or configured to interface with the vehicle, based on the identification information of the desired station being identical to the identification information of the battery swap station.

According to an embodiment, transmitting the request to open the slot to the battery swap station may include: identifying a version of a battery pack mountable in or configured to interface with the vehicle based on the VIN and the software package version; and determining that the target battery pack is the battery pack mountable in or configured to interface with the vehicle based on the identified version of the battery pack mountable in or configured to interface with the vehicle being identical to the second BMS information.

According to an embodiment, transmitting the request to open the slot to the battery swap station may include requesting, from the battery swap station, information regarding a battery pack different from the target battery pack among battery packs included in the battery swap station based on the identified version of the battery pack configured to interface with the vehicle being different from the second BMS information.

According to an embodiment, transmitting the request to open the slot to the battery swap station may include: requesting identification information of a slot in which the target battery pack is stored based on a determination that the target battery pack is the battery pack mountable in or configured to interface with the vehicle; transmitting the request to open the slot to the battery swap station based on receiving the identification information of the slot in which the target battery pack is stored from the battery swap station; encrypting the second battery pack information; and transmitting the encrypted second battery pack information and a symmetric key to the vehicle.

According to an embodiment, transmitting the request to open the slot to the battery swap station may include: receiving, from the vehicle, first battery pack information regarding an existing battery pack that is scheduled to be released; determining to open a slot in which a target battery pack is stored in response to a request to open the slot based on receiving, from a server, the request to open the slot; identifying a coupling of a new battery pack to the slot after the slot is opened and a release of the target battery pack is identified; and performing a verification of the new battery pack based on the new battery pack being coupled to the slot.

According to an embodiment, transmitting the request to open the slot to the battery swap station may include: identifying first identification information and first BMS information included in the first battery pack information received from the server; identifying identification information of the new battery pack and BMS information of the new battery pack; determining whether the first identification information is identical to the identification information of the new battery pack; and determining whether the first BMS information is identical to the BMS information of the new battery pack.

According to an embodiment, transmitting the request to open the slot to the battery swap station may include: transmitting an unverified result to the server based on a determination that the first identification information is not identical to the identification information of the new battery pack, or a determination that the first BMS information is not identical to the BMS information of the new battery pack; transmitting, to a user terminal, an error message indicating that that the existing battery pack is unable or not in a condition to be exchanged based on the unverified result being transmitted to the server; receiving, from the server, encrypted second battery pack information and a symmetry key; and performing a verification of the target battery pack coupled to the vehicle based on the encrypted second battery pack information and the symmetry key.

### BRIEF DESCRIPTION OF THE DRAWINGS

The above and other objects, features and advantages of the present disclosure should be more apparent from the following detailed description taken in conjunction with the accompanying drawings, in which:

FIG. 1 is a block diagram of a server according to an embodiment of the present disclosure;

FIG. 2 is a flowchart for describing a battery swap method according to an embodiment of the present disclosure;

FIG. 3 is a diagram illustrating a server, a vehicle, and a battery swap station in a battery swap system according to an embodiment of the present disclosure;

FIG. 4 is a diagram illustrating an example battery pack coupled to a vehicle;

FIG. 5 is a diagram illustrating an example battery pack coupled to a battery swap station;

FIG. 6 is a diagram illustrating an example interface provided by a vehicle to a user;

FIG. 7 is a flowchart for describing battery swap operations in a battery swap system according to an embodiment of the present disclosure;

FIG. 8 is a flowchart for describing a method of performing verification of a target battery pack, in a server according to an embodiment of the present disclosure;

FIG. 9 is a diagram illustrating an example of a method of transmitting encrypted battery pack information to a vehicle in a server according to an embodiment of the present disclosure; and

FIG. 10 is a diagram illustrating a computing system related to a battery swap system, or a battery swap system according to an embodiment of the present disclosure.

In the description of the drawings, the same or similar reference numerals may be used for the same or similar components.

### DETAILED DESCRIPTION

Hereinafter, some embodiments of the present disclosure are described in detail with reference to the drawings. In adding the reference numerals to the components of each drawing, it should be noted that the identical or equivalent component is designated by the identical numeral even if they are displayed on other drawings. Further, in describing an embodiment of the present disclosure, a detailed description of well-known features or functions has been ruled out in order not to unnecessarily obscure the gist of the present disclosure. In particular, various embodiments of the disclosure may be described with reference to the accompanying drawings. However, this is not intended to limit the technology described herein to specific embodiments, and those of ordinary skill in the art should recognize that modifications, equivalents, and/or alternatives on the various embodiments described herein may be variously made without departing from the scope and spirit of the disclosure. With regard to description of drawings, similar components may be marked by similar reference numerals.

In describing the components of an embodiment according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those having ordinary skill in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application. For example, the terms, such as “first”, “second”, and the like used in the disclosure may be used to refer to various components regardless of the order and/or the priority and to distinguish the relevant components from other components, but do not limit the components. For example, “a first user device” and “a second user device” indicate different user devices regardless of the order or priority. For example, without departing the scope of the disclosure, a first component may be referred to as a second component, and similarly, a second component may be referred to as a first component.

In the disclosure, the expressions “have”, “may have”, “include” and “comprise”, or “may include” and “may comprise” used herein indicate existence of corresponding features (e.g., components such as numeric values, functions, operations, or parts) but do not exclude presence of additional features.

It should be understood that if a component (e.g., a first component) is referred to as being “(operatively or communicatively) coupled with/to” or “connected to” another component (e.g., a second component), it may be directly coupled with/to or connected to the other component or an intervening component (e.g., a third component) may be present. In contrast, if a component (e.g., a first component) is referred to as being “directly coupled with/to” or “directly connected to” another component (e.g., a second component), it should be understood that there are no intervening component (e.g., a third component).

According to the situation, the expression “configured to” used in the disclosure may be used as, for example, the expression “suitable for”, “having the capacity to”, “designed to”, “adapted to”, “made to”, or “capable of”.

The term “configured (or set) to” must not mean only “specifically designed to” in hardware. Instead, the expression “a device configured to” may mean that the device is “capable of” operating together with another device or other parts. For example, a “processor configured to (or set to) perform A, B, and C” may mean a dedicated processor (e.g., an embedded processor) for performing a corresponding operation or a generic-purpose processor (e.g., a central processing unit (CPU) or an application processor) which performs corresponding operations by executing one or more software programs which are stored in a memory device. In other words, when a component, processor, controller, device, element, apparatus, or the like of the present disclosure is described as having a purpose or performing an operation, function, or the like, the component, processor, controller, device, element, apparatus, or the like should be considered herein as being “configured to” meet that purpose or to perform that operation or function. Each component, controller, device, element, apparatus, and the like may separately embody or be included with a processor and a memory, such as a non-transitory computer readable media, as part of the apparatus. Terms used in the disclosure are used to describe specified embodiments and are not intended to limit the scope of the disclosure. The terms of a singular form may include plural forms unless otherwise specified. All the terms used herein, which include technical or scientific terms, may have the same meaning that is generally understood by a person having ordinary skill in the art. It should be further understood that terms, which are defined in a dictionary and commonly used, should also be interpreted as is customary in the relevant related art and not in an idealized or overly formal unless expressly so defined in various embodiments of the disclosure. In some cases, even if terms are terms which are defined in the disclosure, they may not be interpreted to exclude embodiments of the disclosure.

In the disclosure, the expressions “A or B”, “at least one of A or/and B”, or “one or more of A or/and B”, and the like may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included. In describing components of embodiments of the present disclosure, each of the phrases “A or B,” “at least one of A and B,” “at least one of A or B,” “A, B or C,” “at least one of A, B and C,” “at least one of A, B, or C” and “at least one of A, B, or C, or any combination thereof” may include any one of items listed along with a relevant phrase, or any possible combination thereof. In particular, phrases such as “at least one of A, B, or C, or any combination thereof” may include A or B or C or a combination thereof such as AB or ABC and/or the like.

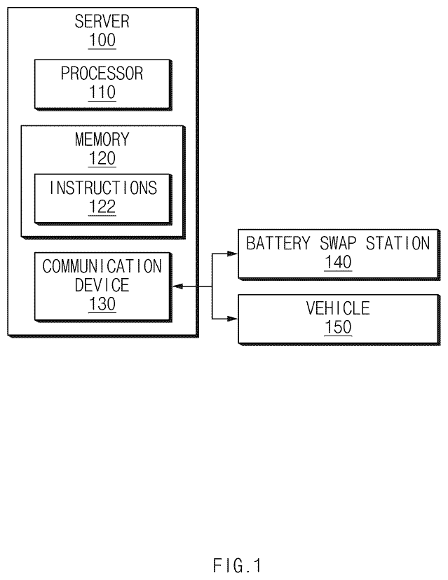

FIG. 1 is a block diagram of a server according to an embodiment of the present disclosure.

A server 100 according to an embodiment may include a processor 110, a memory 120, and a communication device 130. The memory 120 may store computer-executable instructions 122. The processor 110 may execute the instructions 122 stored in the memory 120 to perform control and determination operations for exchanging battery packs.

For example, the server 100 may receive vehicle information (e.g., vehicle identification number (VIN) and software package version) and information on an existing battery pack (i.e., a first battery pack) from a vehicle 150. The information on an existing battery pack may include identification information for a battery pack, battery management system (BMS) information, and diagnostic information.

For example, the server 100 may receive, from a battery swap station 140, station identification information and information on a target battery pack (i.e., a second battery pack). The information on a second battery pack may include identification information, BMS information, and diagnostic information.

For example, the server 100 may determine, based on the collected information, whether the second battery pack is mountable in or configured to interface with the vehicle 150. The server 100 may identify a version of the battery pack that is mountable in or configured to interface with the vehicle 150 by comparing it to the VIN and software package version of the vehicle 150. The server 100 may determine compatibility of the battery pack if information on a desired station for exchange of the battery pack of the vehicle 150 is identical to the identification information of the battery swap station 140. The server 100 may determine that the target battery pack is a battery pack that is mountable in or configured to interface with the vehicle 150 if the BMS information of the second battery pack is identical to the version information of the vehicle.

For example, the server 100 may send a request to open a slot to the battery swap station 140. The server 100 may request and receive information on a slot in which the target battery pack is stored, and issue an open command for the received slot. The server 100 may analyze the diagnostic information of the existing battery pack to determine whether the battery pack is faulty or in a prohibited condition. A battery pack is considered ‘faulty’ when the performance of the battery pack deviates from a normal performance state or when the battery management state deviates from a normal battery management state (e.g., deviates from a normal or predefined threshold range of voltage, temperature, or state of charge (SOC)) and/or the battery pack fails to charge/discharge. The server 100, in the case of a faulty battery pack (e.g., when the battery pack is in a prohibited condition), may send a message to the vehicle indicating that the exchange is not possible or is not to be performed and may additionally provide a guidance message for repair.

For example, the server 100 may encrypt the information of the target battery pack and transmit the encrypted information and a symmetric key to the vehicle 150. The server 100 may increase data security by transmitting encrypted information. The server 100 may request information on another battery pack included in the battery swap station 140 if the second battery pack is not mountable in or configured to interface with the vehicle 150.

The processor 110 may execute software and control at least one other component (e.g., hardware or software component) connected to the processor 110. The processor 110 may also perform various data processing or operations. For reference, it should be noted that the processor 110 may perform all of operations performed by the server 100. Therefore, for ease of description, the operations performed by the server 100 are primarily described herein as operations performed by the processor 110. Furthermore, for ease of description, the processor 110 is primarily described herein as being a single processor, but is not limited thereto. For example, the server 100 may include at least one processor. Each of the at least one processor may perform all of the operations associated with performing control and determination operations for battery pack exchange.

The memory 120 may temporarily and/or permanently store various data and/or information required to perform the control and determination operations for battery pack exchange. For example, the memory 120 may store battery pack information.

The communication device 130 may assist in performing communications among the server 100, the battery swap station 140, and the vehicle 150. For example, the communication device 130 may include one or more components that enable communication among the server 100, the battery swap station 140, and the vehicle 150. For example, the communication device 130 may include a short range wireless communication device, a microphone, and the like. In this case, short range communication technology may include wireless LAN (Wi-Fi), Bluetooth, ZigBee, WFD (Wi-Fi Direct), UWB (ultra-wideband), infrared communication (IrDA, infrared Data Association), and BLE (Bluetooth Low Energy), NFC (Near Field Communication), or the like, but is not limited thereto.

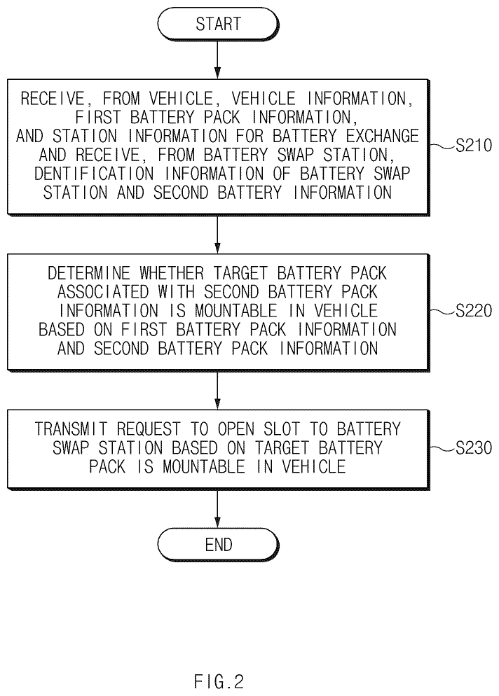

FIG. 2 is a flowchart for describing a battery swap method according to an embodiment of the present disclosure.

A server (e.g., the server 100 of FIG. 1) according to an embodiment may, in operation S210, receive vehicle information, first battery pack information, and station information for battery exchange from a vehicle (e.g., the vehicle 150 of FIG. 1), and receive identification information of a battery swap station (e.g., the battery swap station 140 of FIG. 1) and second battery pack information from the battery swap station.

For example, the vehicle information is data that the server 100 is able to receive from the vehicle 150 and may include information for identifying the vehicle and determining compatibility in the battery pack exchange process. Specifically, the vehicle information may represent a Vehicle Identification Number (VIN), which is a unique identification number to uniquely identify a vehicle, and a software version of software used by the vehicle's control system, and include a software package version used to determine compatibility in the battery pack exchange.

For example, the first battery pack information is data about an existing battery pack currently installed in the vehicle 150, which the server 100 may receive from the vehicle 150. The first battery pack information may include first identification information, which is identification information that uniquely identifies an existing battery pack, first battery management system information (BMS information), which is battery management state information such as voltage, temperature, and state of charge (SOC) of an existing battery pack, and first diagnostic information, which is information indicative of a failure, remaining life, or performance state of the existing battery pack.

For example, the station information is information about a battery swap station 140 that the vehicle 150 has requested to exchange a battery pack, which the server 100 may receive from the vehicle 150. The station information may include identification information of a desired station, which is the identification information of a specific station at which the vehicle 150 has requested exchange of a battery pack, and station location information, which is the location coordinates (e.g., latitude and longitude) or name of a station specified in the request to exchange a battery pack.

For example, the second battery pack information is data about a target battery pack that is stored at the battery swap station 140, which the server 100 may receive from the battery swap station 140. The second battery pack information may include second identification information, which is identification information that uniquely identifies the target battery pack, second BMS information (Battery Management System information), which is battery management state information such as voltage, temperature, and state of charge (SOC) of the target battery pack, and second diagnostic information, which is information indicative of a failure, remaining life, or performance state of the target battery pack.

In operation S220, the server 100 may determine whether the target battery pack associated with the second battery pack information is mountable in or configured to interface with the vehicle 150, based on the first battery pack information and the second battery pack information.

For example, the server 100 may identify the first battery pack information received from the vehicle 150. The server 100 may identify a unique ID of the existing battery pack through the first identification information to track the history of battery pack replacements in the vehicle 150. The server 100 may analyze the state information of the existing battery pack, such as voltage, temperature, and state of charge (SOC) via the first BMS information, to identify the specifications of the battery pack available in the vehicle 150. Through the first diagnostic information, the server 100 may examine failure and performance state of the existing battery pack to determine whether it is appropriate to exchange a battery pack.

For example, the server 100 may identify the second battery pack information received from the battery swap station 140. Through the second identification information, the server 100 may identify a unique ID of the target battery pack to track the state of each battery pack stored at the battery station. Through the second BMS information, the server 100 may identify the state information of the target battery pack, such as voltage, temperature, SOC, or the like to determine whether the state information is identical to battery pack specifications required by the vehicle 150. Through the second diagnostic information, the server 100 may determine whether the target battery pack is faulty or in a prohibited condition and its performance status to determine whether it may be installed in the vehicle 150.

For example, the server 100 may compare the first battery pack information and the second battery pack information to determine compatibility based on the following conditions. Specifically, to determine matching with battery specifications, the server 100 may identify whether key specifications of the target battery pack, such as voltage, capacity, SOC, temperature, and the like are within ranges required by the vehicle 150. For comparison of BMS information, the server 100 may determine if the BMS information of the first battery pack and the BMS information of the second battery pack are compatible with each other. To determine the software compatibility, the server 100 may identify whether the software package version of the vehicle 150 is compatible with the control system (BMS) of the target battery pack. To identify a failure, the server 100 may determine whether there is failure or degradation based on diagnostic information of the target battery pack.

In operation S230, the server 100 may transmit a request to open a slot to the battery swap station 140 based on the target battery pack being mountable in or configured to interface with the vehicle 150. Specifically, the server 100 may transmit the request to open a slot to the battery swap station 140 if the server 100 determines that the target battery pack is mountable in or configured to interface with the vehicle 150. Alternatively, if the server 100 determines that the target battery pack is not mountable in or configured to interface with the vehicle 150, the server 100 may request, from the battery swap station 140, information about another battery pack that is exchangeable, or may transmit a message indicating that battery exchange is not possible or is not to be performed to the vehicle 150.

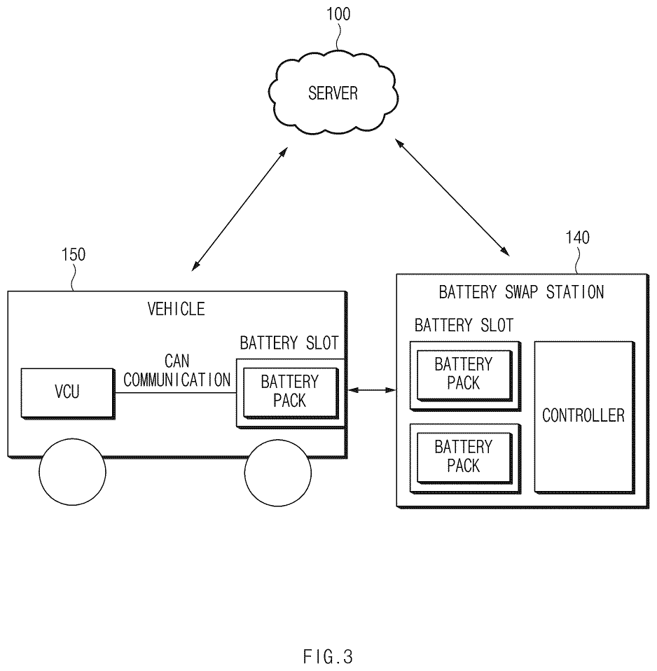

FIG. 3 is a diagram illustrating a server, a vehicle, and a battery swap station in a battery swap system according to an embodiment of the present disclosure.

FIG. 3 is a block diagram illustrating the interaction between the server 100, the vehicle 150, and the battery swap station 140. The vehicle 150, which may be an electric vehicle, may include a battery slot into which a battery pack is inserted and a Vehicle Control Unit (VCU). The vehicle 150 may interact with the server 100 and the battery swap station 140 via CAN communication. The vehicle 150 may transmit information about an existing battery pack (e.g., the first battery pack) that is being replaced to the server 100.

The server 100 may perform information processing and decision-making roles in the battery swap system. For example, the server 100 may receive the first battery pack information from the vehicle 150. The server 100 may receive identification information (BSS ID) and information about a target battery pack (e.g., a second battery pack) from the battery swap station 140. The server 100 may compare the first battery pack information and the second battery pack information to determine whether the second battery pack is mountable in or configured to interface with the vehicle 150. If the second battery pack is determined to be a battery pack being mountable in or configured to interface with the vehicle 150, the server 100 may transmit a request to open a slot to the battery swap station 140.

The battery swap station 140 is a device that performs a battery exchange process and may include a plurality of battery pack slots and a controller. The battery swap station 140 may receive, from the vehicle 150 and/or the server 100, information on an existing battery pack (i.e., the first battery pack) that is scheduled to be released from the vehicle 150. The battery swap station 140 may receive a request to open a specified slot from the server 100 and open the slot in response to the request. The battery swap station 140 may identify that a new battery pack (e.g., a first battery pack) has been coupled to the slot after a target battery pack has been released from the battery swap station 140, and perform a verification of the new battery pack.

The information of the first battery pack, which is the existing battery pack in the vehicle 150, may be transmitted to the server 100. The server 100 may compare the second battery pack information received from the battery swap station 140 with the first battery pack information to determine the compatibility of the second battery pack to be mounted and/or coupled to the vehicle 150. If compatibility is determined, the server 100 may transmit a slot open command to the battery swap station 140. The battery swap station 140 may open the slot in response to the command from the server 100, and perform a process of coupling to and verifying the new battery pack (i.e., the first battery pack from the vehicle 150).

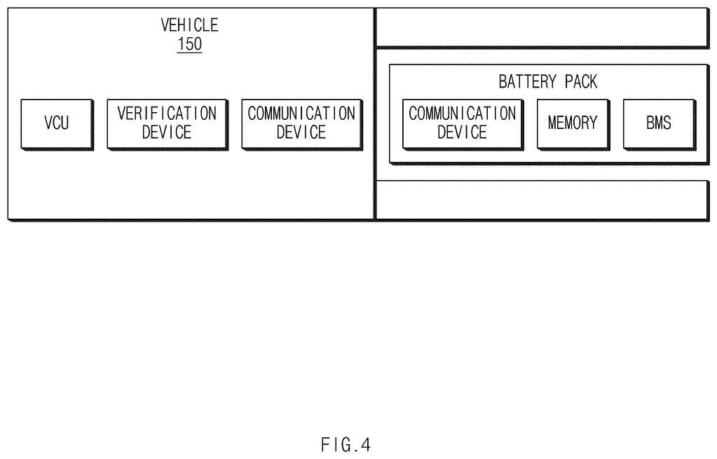

FIG. 4 is a diagram illustrating an example of a battery pack coupled to a vehicle.

The vehicle 150 may include various components that collect and process important information during a battery pack management and exchange process. The vehicle control unit (VCU) is the core control device of the vehicle 150 and may control the flow of data between components within the vehicle 150, such as a battery pack, a verification device, a communication device and the like. The VCU may communicate with the battery pack and the server 100 to transmit and receive state information if the battery pack is exchanged. The verification device may verify the installation state and compatibility of the battery pack. Based on the encrypted battery pack information received from the server 100, the verification device may verify the authenticity of the battery pack. The communication device is a communication module capable of transmitting and receiving data between the vehicle 150, the server 100, and the battery pack, and may use the CAN communication protocol. For example, the communication device may transmit information (e.g., VIN, software package version) of the vehicle 150 and battery pack information (e.g., first battery pack information) to the server 100, and receive exchange request messages or exchange availability from the server 100.

The battery packs in the vehicle 150 are designed as interchangeable modules and may include the following components. For example, the communication device is a communication module in the battery pack that may transmit battery management system (BMS) data to the VCU and the server 100. The communication device may periodically transmit state information of the battery pack and perform a command based on data received from the server 100. The memory may manage information stored in the battery pack, which may include battery pack identification (ID), BMS information, and diagnostic information. The memory may store the battery's lifetime, charge and discharge history, fault history, and the like, which may be referenced by the server 100 and the vehicle 150. The battery management system (BMS) is a management system for a battery pack which may monitor battery states in real time, including voltage, current, temperature, state of charge (SOC), and state of health (SOH). The BMS may ensure the safety and performance of the battery pack and may play an important role in diagnosing faults and determining whether a replacement is required.

The vehicle 150 may transmit and receive data to and from the battery pack and the server 100 via the VCU, the verification device, and the communication device, and play a central role in the battery pack replacement process. The battery pack may monitor a battery state and perform real-time data exchange with the server 100 and the vehicle 150 via the communication device, the memory, and the BMS. The vehicle 150 which receives a command to exchange a battery pack from the server 100 may perform verification and state evaluation of the battery pack and proceed with the exchange process.

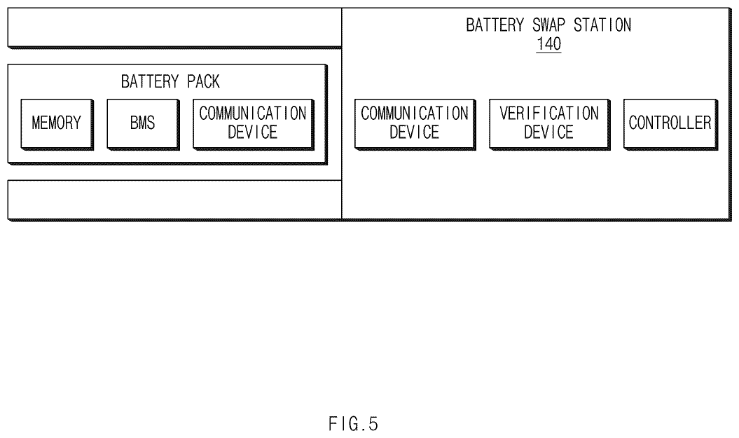

FIG. 5 is a diagram illustrating an example of a battery pack coupled to a battery swap station.

The battery swap station 140 is the core system for exchanging and managing a battery pack of an electric vehicle (i.e., the vehicle 150 of FIG. 1), and may include the following components. The battery swap station 140 may include a communication device that transmits and receives data to and from the vehicle 150 and the server 100. The communication device may receive a request to exchange a battery pack, target battery pack information, a request to open a slot, or the like from the server 100, and transmit a swap state and battery pack information to the vehicle 150 and the server 100. The verification device may verify that the battery pack installed or changed at the station is a certified battery pack. The verification device may compare the battery pack information (e.g., identification information, diagnostic information, and the like) with the server 100 and the vehicle 150 to prevent the use of an incompatible battery pack during the exchange process. The controller may control physical operations (e.g., opening and/or closing battery pack slots, and the like) in the battery swap station 140 and automatically perform a battery exchange process by receiving a command from the server 100. The controller may monitor a battery pack exchange status and transmit state information to the server 100 and the vehicle 150 in the event of an abnormal situation.

The battery packs managed by the battery swap station 140 may be designed as interchangeable modules and may include the following components. The memory may store the unique ID, diagnostic information, charge/discharge history, lifetime information, and the like of a battery pack and provide corresponding information to the server 100 and the vehicle 150. The battery management system (BMS) may manage state information of the battery pack, such as voltage, current, state of charge (SOC), and state of health (SOH) in real time, and ensure the performance and safety of the battery pack. The BMS may provide diagnostic data to the server 100 and the station during exchange to support the assessment of suitability. The communication device may transmit state information of the battery pack (e.g., BMS data, diagnostic information) to the battery swap station 140, and receive a command required during the exchange process.

If the vehicle 150 arrives at the battery swap station 140, the station may receive the battery pack information from the vehicle 150 and determine its suitability through the verification device. The control device may open a slot where a suitable battery pack is stored and install a new battery pack into the vehicle 150, according to the command received from the server 100. The information on the replaced battery pack may be transmitted to the server 100 and the vehicle 150, and the exchange process may be completed.

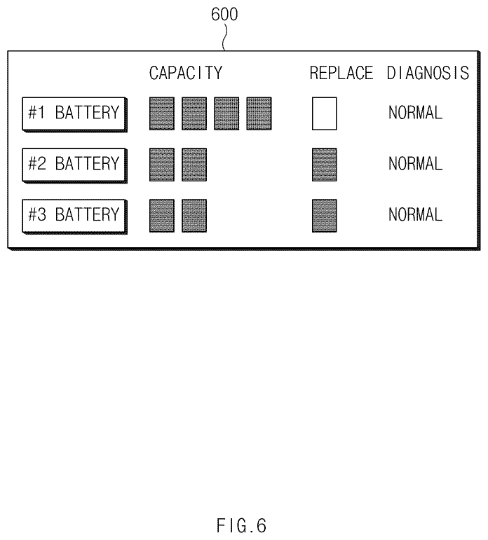

FIG. 6 is a diagram illustrating an example of an interface provided by a vehicle to a user.

The vehicle 150 may display the state information of a battery currently in use among the N battery packs, via an interface 600, or provide the information to a user via a mobile device. The vehicle 150 may display the following information for each battery pack (e.g., #1 battery, #2 battery, #3 battery) on the interface 600.

The vehicle 150 may visually display the current state of charge (SOC) of each battery pack via the interface 600. For example, the vehicle 150 may visually highlight (by displaying a different color or state) batteries that have low state of charge via the interface 600. The vehicle 150 may provide the user with a replacement state (e.g., red or highlighted) for a battery that needs to be replaced via the interface 600. The vehicle 150 may display the state of the battery pack as either “Normal” or “Abnormal” and provide the fault state to the user through the interface 600.

If the vehicle 150 arrives at the battery swap station 140, the user (e.g., the driver) may request a replacement of the battery pack via the vehicle display or mobile device (i.e., via the interface 600). For example, upon requesting a replacement, the vehicle 150 may transmit to the server 100 information to uniquely identify the vehicle 150, such as a vehicle identification number (VIN), and information about the software version used in the vehicle's control system, such as vehicle control unit (VCU) software information.

The server 100 may identify a list of compatible battery packs that have received safety certification among the batteries of the station based on the information received from the vehicle 150. The server 100 may identify the state information of the battery packs included in the list of compatible battery packs, verify the battery state through the voltage, temperature, SOC, or the like of each battery pack, and determine whether the battery packs included in the list are exchangeable.

The result of verification by server 100 may be displayed to the user through the vehicle display or mobile interface. The user may proceed with the battery exchange process or receive additional instructions (e.g., requirement for battery charging or repair) if a problem occurs.

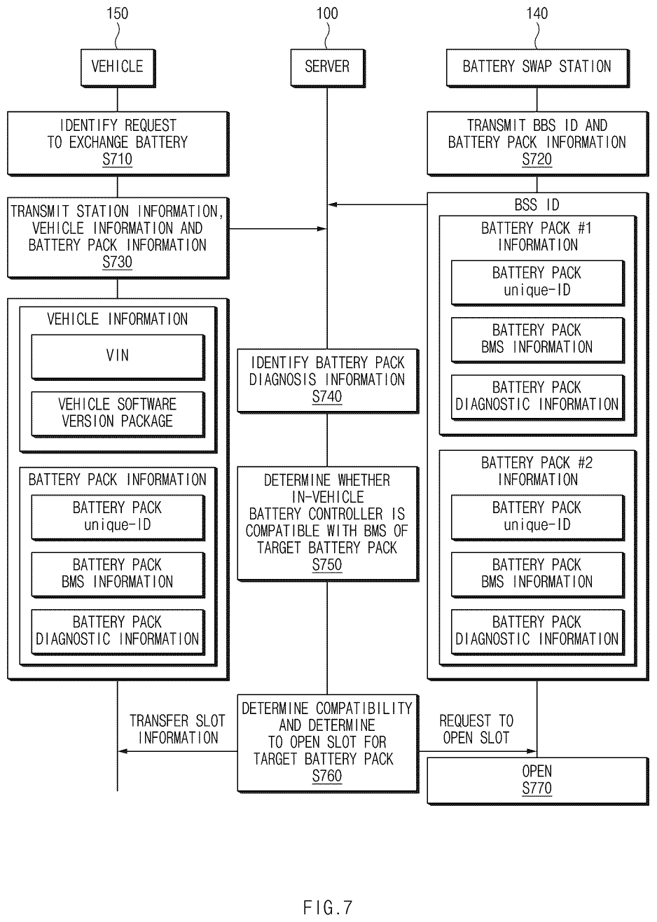

FIG. 7 is a flowchart for describing a battery swap operation in a battery swap system according to an embodiment of the present disclosure.

Referring to FIG. 7, the vehicle 150 may identify a request to exchange a battery pack in operation S710. For example, the vehicle 150 may identify the request to exchange a battery pack based on a user's request.

The battery swap station 140 may transmit second battery pack information to the server 100 in operation S720. Specifically, the second battery pack information may include second identification information on a target battery pack included in the battery swap station 140, the second BMS information of the target battery pack, and the second diagnostic information of the target battery pack.

The vehicle 150 may transmit station information, vehicle information, and battery pack information to the server 100 in operation S730. For example, the server 100 may receive the vehicle information from the vehicle 150. Specifically, the vehicle information may include a VIN (Vehicle Identification Number) of the vehicle 150 and a software package version of the vehicle 150. Additionally, the server 100 may receive first battery pack information from the vehicle 150. The first battery pack information may include the first identification information of an existing battery pack included in the vehicle 150, the first BMS information of the existing battery pack, and the first diagnostic information of the existing battery pack.

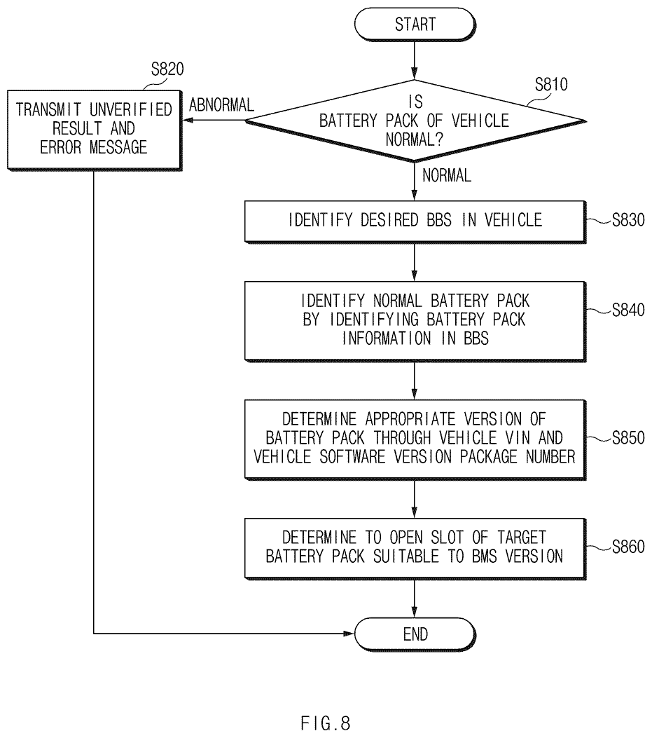

The server 100 may identify the battery pack diagnostic information in operation S740. Specifically, the server 100 may identify the first diagnostic information included in the first battery pack information in operation S740. A detailed description related thereto is described below with reference to FIG. 8.

The server 100 may determine whether the battery controller in the vehicle 150 is compatible with the BMS of the target battery pack in operation S750. A detailed description regarding this is given below with reference to FIG. 8.

The server 100 may determine the compatibility in operation S760 and determine to open a slot to which the target battery pack is coupled. Accordingly, the battery swap station 140 may open the slot to which the target battery pack is coupled in operation S770.

The battery swap station 140 may receive the first battery pack information on an existing battery pack which is scheduled to be released from the vehicle 150. The battery swap station 140 may determine to open the slot according to a request to open the slot based on receiving the request to open a slot in which the target battery pack is stored from the server 100. The battery swap station 140 may identify the combination of a new battery pack for the slot after the slot is opened and the release of the target battery pack is identified. In this example, the new battery pack may include an existing battery pack that has been released from the vehicle 150.

The battery swap station 140 may perform verification of the new battery pack if the new battery pack is coupled to the slot. Specifically, the battery swap station 140 may identify the first identification information and the first BMS information included in the first battery pack information received from the server 100. The battery swap station 140 may identify the identification information of the new battery pack and the BMS information of the new battery pack.

The battery swap station 140 may determine whether the first identification information is identical to the identification information of the new battery pack, and whether the first BMS information is identical to the BMS information of the new battery pack. Specifically, the battery swap station 140 may transmit an unverified result to the server 100 if the first identification information is not identical to the identification information of the new battery pack, or if the first BMS information is not identical to the BMS information of the new battery pack. The battery swap station 140 may transmit an error message indicating that the battery is unable or not in a condition to be exchanged to the user terminal if the unverified result is transmitted to the server 100.

FIG. 8 is a flowchart for describing a method of performing verification of a target battery pack in a server according to an embodiment of the present disclosure.

Referring to FIG. 8, a server (e.g., the server 100 of FIG. 1) may determine whether a battery pack of a vehicle is normal in operation S810. Specifically, the server may determine whether an existing battery pack is faulty or in a prohibited condition based on first diagnostic information.

The server may transmit, to the vehicle, a result message indicating that the existing battery pack is unable or not in a condition to be changed at the battery swap station if the existing battery pack is faulty (or in a prohibited condition) and/or abnormal, in operation S820. In addition, the server may transmit, to the vehicle, a guide message regarding repair of the existing battery pack if the result message is transmitted to the vehicle.

In operation S830, if the existing battery pack is not faulty or not in a prohibited condition, the server may identify identification information of a desired station for exchange of the vehicle's battery pack included in the station information for battery pack exchange.

In operation S840, the server may identify a normal battery pack included in the battery swap station after identifying the information on battery packs in the battery swap station.

In operation S850, the server may determine a suitable version of the battery pack, based on a vehicle VIN and a vehicle software package version number. Specifically, the server may identify a version of the battery pack that is mountable in or configured to interface with the vehicle (i.e., a BMS version) based on the VIN and the software package version.

The server may determine whether the target battery pack is mountable in or configured to interface with the vehicle based on the first battery pack information and the second battery pack information, if the identification information of the desired station is identical to the identification information of the battery swap station. The server may determine that the target battery pack is a battery pack mountable in or configured to interface with the vehicle if the identified version of the battery pack is identical to the second BMS information.

In operation S860, the server may determine to open a slot for the target battery pack that is suitable for the BMS version. Specifically, the server may determine that the target battery pack is a battery pack mountable in or configured to interface with the vehicle if the identified version of the battery pack is identical to the second BMS information, and determine to open a slot for the target battery pack that is suitable for the BMS version.

If the identified version of the battery pack is different from the second BMS information, the server may request, from the battery swap station, information regarding a battery pack different from the target battery pack from among battery packs included in the battery swap station.

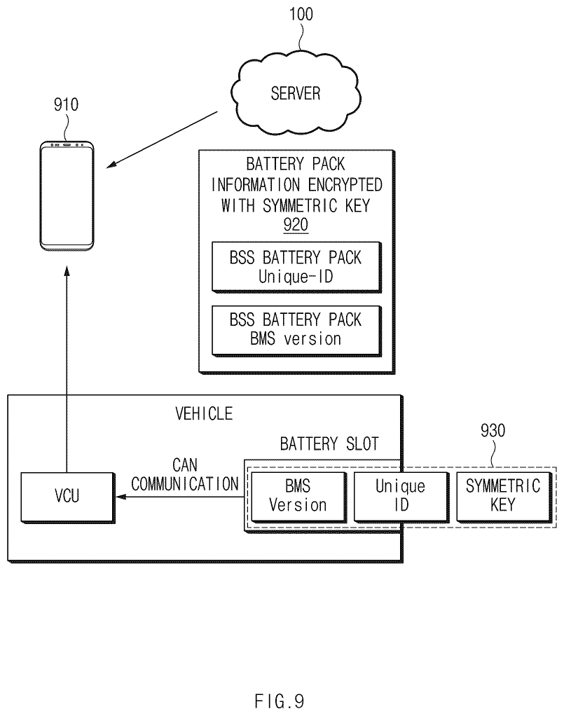

FIG. 9 is a diagram illustrating an example of a method for transmitting encrypted battery pack information to a vehicle in a server according to an embodiment of the present disclosure.

FIG. 9 is a block diagram specifically illustrating a process of selecting, verifying, and exchanging a target battery pack through data flow between the vehicle 150, the server 100, and a battery swap station.

The vehicle 150 may collect information on a currently installed battery pack through a battery management system (BMS). The battery pack may transmit a BMS version and identification information (unique ID) to a VCU (Vehicle Control Unit) of the vehicle 150 through CAN communication. The VCU of the vehicle 150 may perform a request to exchange a battery, and upon request, encrypt and transmit data including the VIN (Vehicle Identification Number) and VCU software information of the vehicle 150 to the server 100.

The server 100 may encrypt the unique ID and BMS version of the target battery pack and then transmit the encrypted battery pack information and a symmetric key to the vehicle 150. The server 100 may apply encryption technology to ensure the integrity and security of data. The vehicle 150 may identify data by utilizing the encrypted battery pack information and the symmetric key received from the server 100. Specifically, the vehicle 150 may verify whether the target battery pack is an authenticated battery pack by comparing the data identified through the VCU with the BMS data of the battery pack. The VCU of the vehicle 150 may determine whether a battery pack is normal by identifying the state of the battery pack after the verification is completed. After the battery pack exchange process is completed, the vehicle 150 may transmit the state of the exchanged battery pack to the server 100 and the battery swap station to finally complete the exchange process.

Specifically, if the target battery pack is determined to be a battery pack mountable in or configured to interface with the vehicle 150, the server 100 may request identification information of the slot in which the target battery pack is stored and transmit the received request to open the slot to the battery swap station. Thereafter, the server 100 may encrypt the second battery pack information and transmit the encrypted second battery pack information and the symmetric key to the vehicle 150. The battery pack information 920 encrypted with the symmetric key may include second battery pack information including the identification information of the battery pack and the BMS version of the battery pack. The vehicle 150 may receive the encrypted second battery pack information and the symmetric key from the server 100 and perform verification of the target battery pack coupled to the vehicle 150 based on the encrypted second battery pack information and the symmetric key.

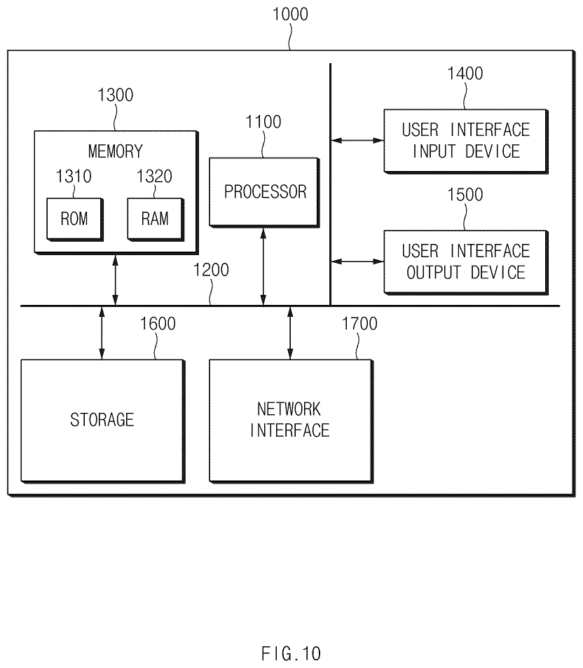

FIG. 10 is a diagram illustrating a computing system related to a battery swap system or a battery swap method according to an embodiment of the present disclosure.

Referring to FIG. 10, a computing system 1000 for a battery swap system or a battery swap method may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a Read Only Memory (ROM) and a Random Access Memory (RAM).

Thus, the operations of the method or the algorithm described in connection with embodiments disclosed herein may be embodied directly in hardware or a software module executed by the processor 1100, or in a combination thereof. The software module may reside on a storage medium (i.e., the memory 1300 and/or the storage 1600) such as a RAM, a flash memory, a ROM, an EPROM, an EEPROM, a register, a hard disk, a removable disk, and a CD-ROM.

The storage medium may be coupled to the processor 1100, and the processor 1100 may read information out of the storage medium and may record information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The above description is merely illustrative of the technical idea of the present disclosure, and various modifications and variations may be made without departing from the essential characteristics of the present disclosure by those having ordinary skill in the art to which the present disclosure pertains.

Embodiments described herein may be implemented with hardware components and software components and/or a combination of the hardware components and the software components. For example, the apparatus, method and components described in embodiments may be implemented using a general-purpose or special purpose computers, such as a processor, a controller and an arithmetic logic unit (ALU), a digital signal processor, a microcomputer, a field programmable array (FPGA), a programmable logic unit (PLU), a microprocessor or any other device capable of executing and responding to instructions. The processing device may run an operating system (OS) and a software application that run on the OS. The processing device also may access, store, manipulate, process, and create data in response to execution of the software. For convenience of understanding, one processing device is described as being used, but those having ordinary skill in the art should appreciate that the processing device includes a plurality of processing elements and/or multiple types of processing elements. For example, the processing device may include multiple processors or a single processor and a single controller. In addition, different processing configurations are possible, such a parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by a computer readable recording media.

The above-described methods may be embodied in the form of program instructions that may be executed by various computer means and recorded on a computer-readable medium. The computer-readable medium may include program instructions, data files, data structures, and/or the like, singly or in combination, and the program instructions recorded on the medium may be those specially designed and constructed for the purposes of the inventive concept, or they may be of the kind well-known and available to those having skill in the computer software arts. Examples of computer readable recording media include magnetic media such as hard disks, floppy disks and magnetic tape, optical media such as CD-ROMs, DVDs, and magnetic disks such as floppy disks, Magneto-optical media, and hardware devices specifically configured to store and execute program instructions, such as ROM, RAM, flash memory, and the like. Examples of program instructions include not only machine code generated by a compiler, but also high-level language code that may be executed by a computer using an interpreter or the like.

The hardware device described above may be configured to operate as one or a plurality of software modules to perform the operations of the present disclosure, and vice versa.

Although the present disclosure have been described by limited embodiments and the drawings as described above, various modifications and variations are possible to those having ordinary skill in the art from the above description. For example, the described techniques may be performed in a different order than the described method, and/or components of the described systems, structures, devices, circuits, and the like may be coupled or combined in a different form than the described method, or other components, or even if replaced or substituted by equivalents, an appropriate result may be achieved.

Therefore, other implementations, other embodiments, and equivalents to the claims are within the scope of the following claims.

Accordingly, an embodiment disclosed in the present disclosure is not intended to limit the technical idea of the present disclosure but to describe the present disclosure, and the scope of the technical idea of the present disclosure is not limited by an embodiment. The scope of protection of the present disclosure should be interpreted by the following claims, and all technical ideas within the scope equivalent thereto should be construed as being included in the scope of the present disclosure.

The effects of the battery swap system and the method thereof according to one or more embodiments of the present disclosure are given as follows.

According to at least one of embodiments of the present disclosure, it is possible to minimize or reduce the likelihood that a faulty battery pack is missed or otherwise a problem arises during the swap process by allowing a battery pack to be submitted for exchange after a server has verified diagnostic information for the battery pack in advance.

Further, according to at least one of embodiments of the present disclosure, it is possible to prevent vehicle performance degradation and safety issues and improve user experience by checking a vehicle's software package version and in-station battery pack information in real-time to ensure that only battery packs that are exactly compatible with the vehicle are exchanged.

Further, according to at least one of embodiments of the present disclosure, it is possible to prevent the use of non-verified battery packs and increase the reliability and safety of vehicles and stations by encrypting battery pack information in a server for cross-checking to ensure that the battery packs provided at a station are verified products.

In addition, various effects may be provided that are directly or indirectly understood through the disclosure.

Hereinabove, although the present disclosure has been described with reference to embodiments and the accompanying drawings, the present disclosure is not limited thereto, but may be variously modified and altered by those having ordinary skill in the art to which the present disclosure pertains without departing from the spirit and scope of the present disclosure claimed in the following claims.

What is claimed is:

1. A server comprising:
a memory configured to store computer-executable instructions; and
a processor configured to access the memory to execute the computer-executable instructions,
wherein the processor is further configured to
receive first battery pack information from a vehicle,
receive identification information of a battery swap station and second battery pack information from the battery swap station,
determine whether a target battery pack associated with the second battery pack information is configured to interface with the vehicle based on the first battery pack information and the second battery pack information, and
transmit a request to open a slot to the battery swap station based on a determination that the target battery pack is configured to interface with the vehicle.

2. The server of claim 1, wherein the processor is further configured to receive vehicle information from the vehicle,
wherein the vehicle information includes a vehicle identification number (VIN) of the vehicle and a software package version of the vehicle,
wherein the first battery pack information includes first identification information of an existing battery pack included in the vehicle, first BMS information of the existing battery pack, and first diagnostic information of the existing battery pack, and
wherein the second battery pack information includes second identification information of the target battery pack included in the battery swap station, second BMS information of the target battery pack, and second diagnostic information of the target battery pack.

3. The server of claim 2, wherein the processor is further configured to:
determine whether the existing battery pack is in a prohibited condition based on the first diagnostic information;
transmit, to the vehicle, a result message indicating that exchange is not to be performed at the battery swap station based on a determination that the existing battery pack is in the prohibited condition; and
transmit, to the vehicle, a guidance message regarding repair of the existing battery pack based on the result message being transmitted to the vehicle.

4. The server of claim 3, wherein the processor is further configured to:
identify identification information of a target station for battery pack exchange of the vehicle, included in station information for battery pack exchange, based on a determination that the existing battery pack is not in the prohibited condition; and
determine, based on the first battery pack information and the second battery pack information, whether the target battery pack is configured to interface with the vehicle, based on the identification information of the target station being identical to the identification information of the battery swap station.

5. The server of claim 4, wherein the processor is further configured to:
identify a version of a battery pack configured to interface with the vehicle based on the VIN and the software package version; and
determine that the target battery pack is configured to interface with the vehicle based on the identified version of the battery pack configured to interface with the vehicle being identical to the second BMS information.

6. The server of claim 5, wherein the processor is further configured to request, from the battery swap station, information regarding a battery pack different from the target battery pack among battery packs included in the battery swap station based on the identified version of the battery pack configured to interface with the vehicle is different from the second BMS information.

7. The server of claim 5, wherein the processor is further configured to:
request identification information of a slot in which the target battery pack is stored based on a determination that the target battery pack is configured to interface with the vehicle;
transmit the request to open the slot to the battery swap station based on receiving the identification information of the slot in which the target battery pack is stored from the battery swap station;
encrypt the second battery pack information; and
transmit the encrypted second battery pack information and a symmetric key to the vehicle.

8. A battery swap system comprising:
a battery swap station;
a vehicle; and
a server,
wherein the battery swap station is configured to
receive, from the vehicle, first battery pack information regarding an existing battery pack that is scheduled to be released,
determine to open a slot in which a target battery pack is stored based on receiving, from the server, a request to open the slot,
determine a coupling of a new battery pack to the slot after the slot is opened and a release of the target battery pack is determined, and
perform a verification of the new battery pack based on the new battery pack being coupled to the slot.

9. The battery swap system of claim 8, wherein the battery swap station is further configured to:
identify first identification information and first BMS information included in the first battery pack information received from the server;
identify identification information of the new battery pack and BMS information of the new battery pack;
determine whether the first identification information is identical to the identification information of the new battery pack; and
determine whether the first BMS information is identical to the BMS information of the new battery pack.

10. The battery swap system of claim 9, wherein the battery swap station is further configured to:
transmit an unverified result to the server based on a determination that the first identification information is not identical to the identification information of the new battery pack, or a determination that the first BMS information is not identical to the BMS information of the new battery pack; and
transmit, to a user terminal, an error message indicating that the existing battery pack is not in a condition to be exchanged based on the unverified result being transmitted to the server, and
wherein the vehicle is configured to
receive, from the server, encrypted second battery pack information and a symmetry key and
perform a verification of the target battery pack coupled to the vehicle based on the encrypted second battery pack information and the symmetry key.

11. A battery swap method comprising:
receiving, from a vehicle, first battery pack information;
receiving, from a battery swap station, identification information of the battery swap station and second battery pack information;
determining whether a target battery pack associated with the second battery pack information is configured to interface with the vehicle based on the first battery pack information and the second battery pack information; and
transmitting a request to open a slot to the battery swap station based on a determination that the target battery pack is configured to interface with in the vehicle.

12. The battery swap method of claim 11, wherein transmitting the request to open the slot to the battery swap station includes receiving vehicle information from the vehicle,
wherein the vehicle information includes a vehicle identification number (VIN) of the vehicle and a software package version of the vehicle,
wherein the first battery pack information includes first identification information of an existing battery pack included in the vehicle, first BMS information of the existing battery pack, and first diagnostic information of the existing battery pack, and
wherein the second battery pack information includes second identification information of the target battery pack included in the battery swap station, second BMS information of the target battery pack, and second diagnostic information of the target battery pack.

13. The battery swap method of claim 12, wherein transmitting the request to open the slot to the battery swap station further includes:
determining whether the existing battery pack is in a prohibited condition based on the first diagnostic information;
transmitting, to the vehicle, a result message indicating that exchange is not to be performed at the battery swap station based on a determination that the existing battery pack is in the prohibited condition; and
transmitting, to the vehicle, a guidance message regarding repair of the existing battery pack based on the result message being transmitted to the vehicle.

14. The battery swap method of claim 13, wherein transmitting the request to open the slot to the battery swap station further includes:
identifying identification information of a target station for battery pack exchange of the vehicle, included in station information for battery pack exchange, based on a determination that the existing battery pack is not in the prohibited condition; and
determining, based on the first battery pack information and the second battery pack information, whether the target battery pack is configured to interface with the vehicle, based on the identification information of the target station being identical to the identification information of the battery swap station.

15. The battery swap method of claim 14, wherein transmitting the request to open the slot to the battery swap station further includes:
identifying a version of a battery pack configured to interface with the vehicle based on the VIN and the software package version; and
determining that the target battery pack is configured to interface with the vehicle based on the identified version of the battery pack configured to interface with the vehicle being identical to the second BMS information.

16. The battery swap method of claim 15, wherein transmitting the request to open the slot to the battery swap station further includes requesting, from the battery swap station, information regarding a battery pack different from the target battery pack among battery packs included in the battery swap station based on the identified version of the battery pack configured to interface with the vehicle being different from the second BMS information.

17. The battery swap method of claim 15, wherein transmitting the request to open the slot to the battery swap station includes:
requesting identification information of a slot in which the target battery pack is stored based on a determination that the target battery pack is configured to interface with the vehicle;
transmitting the request to open the slot to the battery swap station based on receiving the identification information of the slot in which the target battery pack is stored from the battery swap station;
encrypting the second battery pack information; and
transmitting the encrypted second battery pack information and a symmetric key to the vehicle.

18. The battery swap method of claim 15, wherein transmitting the request to open the slot to the battery swap station includes:
receiving, from the vehicle, first battery pack information regarding an existing battery pack that is scheduled to be released;
determining to open a slot in which a target battery pack is stored based on receiving, from a server, a request to open the slot;
identifying a coupling of a new battery pack to the slot after the slot is opened and a release of the target battery pack is identified; and
performing a verification of the new battery pack based on the new battery pack being coupled to the slot.

19. The battery swap method of claim 18, wherein transmitting the request to open the slot to the battery swap station further includes:
identifying the first identification information and the first BMS information included in the first battery pack information received from the server;
identifying identification information of the new battery pack and BMS information of the new battery pack;
determining whether the first identification information is identical to the identification information of the new battery pack; and
determining whether the first BMS information is identical to the BMS information of the new battery pack.

20. The battery swap method of claim 19, wherein transmitting the request to open the slot to the battery swap station further includes:
transmitting an unverified result to the server based on a determination that the first identification information is not identical to the identification information of the new battery pack, or a determination that the first BMS information is not identical to the BMS information of the new battery pack;
transmitting, to a user terminal, an error message indicating that that the existing battery pack is not in a condition to be exchanged based on the unverified result being transmitted to the server;
receiving, from the server, encrypted second battery pack information and a symmetry key; and
performing a verification of the target battery pack coupled to the vehicle based on the encrypted second battery pack information and the symmetry key.
